(19) United States
(12) Patent Application Publication
(10) Pub. No.: US 2016/0185095 A1
(43) Pub. Date: Jun. 30, 2016

(54) DECORATIVE PANELS AND PROCESSES FOR THE MAKING THEREOF

(71) Applicant: Tomas Espinosa Braniff, Colonia Bosques de las Lomas (MX)

(72) Inventor: Tomas Espinosa Braniff, Colonia Bosques de las Lomas (MX)

(21) Appl. No.: 14/836,814

(22) Filed: Aug. 26, 2015

Related U.S. Application Data
(63) Continuation of application No. 13/704,591, filed on Feb. 28, 2013, now abandoned.

(30) Foreign Application Priority Data
Jun. 15, 2010 (MX) MX/A/2010/006595

(51) Int. Cl. B32B 38/00; B44C 3/02; B32B 7/12

(52) U.S. Cl. CPC B32B 38/0012; B32B 7/12; B44C 3/02

(57) ABSTRACT

The present invention relates to processes for making decorative or artistic panels on glass surfaces and polymeric surfaces in multiple layers and their application in commercial and artistic decoration, such as dividing walls, ceilings, pictorial pictures, sculptures, floor lamps, desk or ceiling lamps, spectacular domes, stained glass, shower wall, as well as to decorate residential and industrial spaces.

### FIELD OF INVENTION

The present invention relates to processes of making decorative and/or artistic panels on a variety of surfaces. The present invention further relates to the use of decorative panels in a variety of functional and commercial settings, such as dividing walls, ceilings, pictorial pictures, sculptures, floor lamps, table or ceiling lamps, spectacular domes, stained glass, shower walls, as well as for residential and industrial decorating purposes.

### BACKGROUND OF THE INVENTION

At present diverse processes exist to make decorative panels with an artistically finished surface, patents MX 141424, MX 148972, MX 157641, MX 149972 described coatings with enhancement or pictorial and are based on the use of ink or paint on a surface to obtain a desired texture on the surface that can be painted. In addition, the patent MX 188958 of the same inventor describes a process to obtain artistic or decorative impressions in multiple layers on polymeric surfaces, all these processes described in those documents are different from the process of the present invention. One reason is that no such processes obtain a color that has different shades and tonalities from light solving the problematic of the decoration. Further, in some aspects, the process of the present invention utilizes materials from old and no longer used auto glass, such as windshield glass, thus aiding to solve the problem of this automotive industry's waste by recycling and giving a new use to this type of waste. In addition, the present invention is economic and fast, and allows to take decorative panels to houses of social interest creating and solving the problem of decoration if we considered that another type of decorative panels are extremely expensive.

Among others applications that disclose compositions and processes to apply designs in glasses or plastics there exists the application PT 12153994 E that refers to a composition of organic painting that include from 80% to 95% in weight of a paint based in epoxy polyurethane, 0.5% to 8% in weight of an additive which it includes a polyethylene waxes mixture and of waxes of polytetrafluoroethylene from 1% to 7% in weight of an agent produced of a polyamide of low molecular weight that preferably is adding before applying the painting composition.

The application JP2002001894 A discloses a process for the elaboration of a decorative sheet that includes a method to make a decorative sheet where the model of the natural wood transfers itself to the surface of an inorganic raw material.

The present invention is considered by the respective inventors to be new and inventive over the documents above mentioned.

### BRIEF DESCRIPTION OF THE FIGURES

FIG. 1, is a lateral view of the panel, where (1) it represents the lamina base, (2) it represents the glass piece selected of car windshield and/or glasses united with a plastic film and (3) it represents the upper surface of the piece of glass.

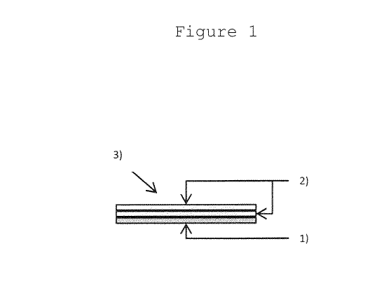

FIG. 2, is a frontal view of a panel with figures, where (4) it represents acrylic lacquer or of nitrocellulose, (5) it represents the glass, (6) a form painted with acrylic lacquer or of nitrocellulose, (7) it represents acrylic lamina, (8) acrylic lacquer or of nitrocellulose on the acrylic lamina, (9) it represents the silicone in which a color composition becomes congested, (10) it represents pieces of acrylic lamina, (11) free space to give volume to the panel, (12) represents the glass, (13) represents acrylic lamina, (14) it represents the lamina acrylic base and the glass piece.

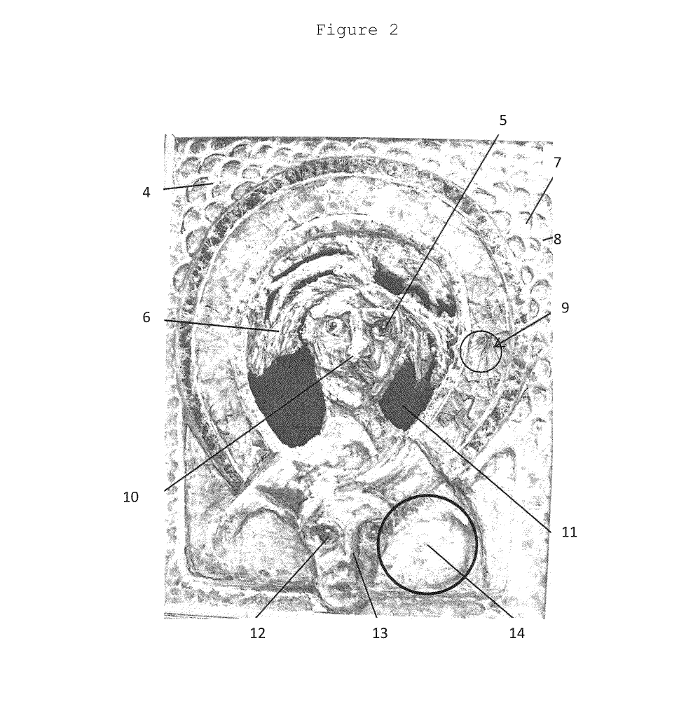

FIG. 3, is a frontal view of a panel with drawing, where (15) it represents the acrylic lamina base transparency, (16) it represents the painted lamina base, (17) represents nitrocellulose lacquer on the lamina base, (18) represents the windshield glass piece in which the upper of the glass has taken off leaving exhibited the plastic film that can be painted with lacquer.

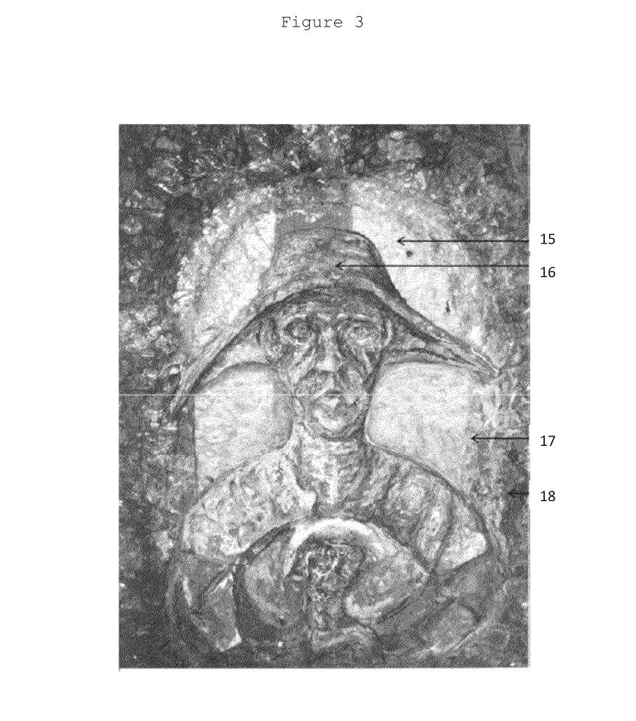

FIG. 4, is a frontal view of a panel with figures, where (19) it represents an acrylic lamina on a metallic lamina base, (20) it represents the glass piece, (21) represents the glass incrustations in the acrylic lamina, (22) the glass piece of windshield of clearly dark color forming the head of the figure, (23) represents the glass of windshield with glass incrustations, (24) it represents the glass of windshield in color and (25) the painted acrylic lamina.

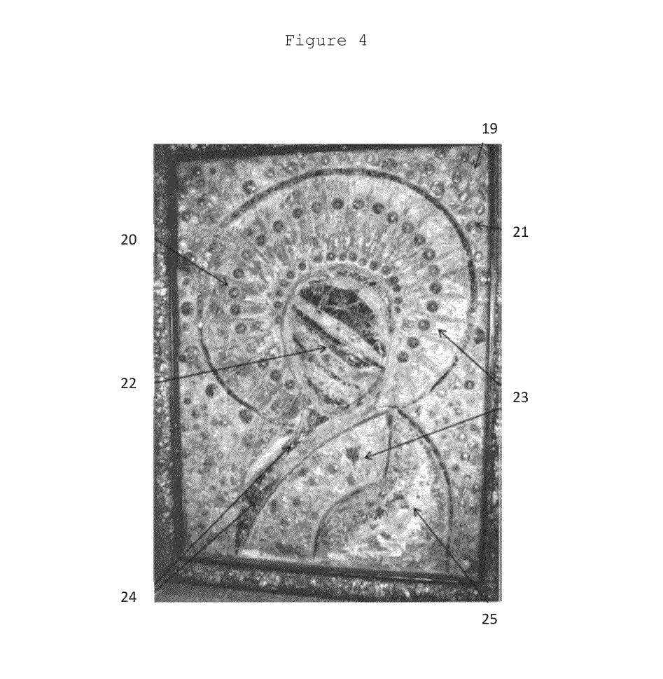

### DESCRIPTION OF THE INVENTION

The present invention relates to a process to make decorative and/or artistic panels on glass surfaces and in multiple layers on polymeric surfaces and their application in commercial and artistic decoration like dividing walls, ceilings, pictorial pictures, sculptures, floor lamps, table or ceiling lamps, spectacular domes, stained glass, shower walls, as well as to decorate spaces in the home, cultural, schools, museums and in the industry.

The process of the present invention provides economic and fast ways of obtaining stained glasses, avoiding with this the lead use that is a toxic and polluting element.

The obtained glass surprisingly has different textures, due to the use of a plastic sheet and different color shades can be obtained with different tonalities of light, this solves the problematic of decoration.

Dividing walls can be done in fast and economic ways, ceilings, pictorial pictures, sculptures, floor lamps, table ceiling or desk lamps, spectacular domes, stained glass, shower walls in a time frame that varies from 1 day up to 5 days depending on the selected design.

In addition, this is a fast and economic procedure, reason why, decorative panels in houses of social interest can be used creating and help solve the problems of decorating; if we considered that other type of decorative panels is extremely expensive because of the utilized materials and the time of manufacture.

This procedure uses automobile glass, such as that of a windshield, for example a used windshield, thus solving in addition the problems of this waste by the automotive industry, recycling and giving a new use to this type of waste.

The process of the present invention includes the following steps:
a) Select the glass pieces in dimensions that vary from 15 cm up to 1000 cm in width, pieces from 15 cm up to 1000 cm in length and from 6 mm up to 60 mm in thickness, these pieces can be of selected transparent colors, like green, gray, pink, blue glass and/or combinations of the same, the glass pieces are selected of glass, for example, automotive glass, including windshield glasses and/or glass united with a plastic film, the same type of plastic film used in the windshield.
b) Unite two glass pieces.
c) Polish the surface of one or both glass pieces according to a selected design that it can be united figures or united lines, these can be, if desired, painted.
d) Inject a composition of color to the figure formed between the two glass pieces or break one or both faces of the outer surfaces of the glass piece and apply a color composition.
e) Break one or both outer surfaces of the glass piece leaving the plastic film exposed, according to the selected design that it can be united figures or united lines.
f) Break the plastic film leaving one or several orifices. The orifices can vary from 1 up to 1000 or from 0 up to 30, to inlay glasses of colors or metals selected from aluminum, bronze or iron.
g) Seal or stick the orifices with a glue selected of silicone, acrylic resin or of nitrocellulose and glue for glass.
h) Stick the glass piece obtained with glue to a film base selected of a polymeric and/or metallic film, the polymeric film is selected of acrylics, of polystyrene, cellulose acetate and polycarbonate, the metallic film is selected of aluminum, iron, bronze and copper, the purpose of this film base is to maintain the glass piece.
i) Make the panel with the film base with the glass piece stuck according to the design of dividing walls, ceilings, pictorial pictures, sculptures, floor lamps, desk or ceiling lamps, spectacular domes, stained glass and shower walls.

In one embodiment the present invention process comprises the following steps:
a) Select the glass pieces in dimensions that vary from 15 cm up to 1000 cm in width, glass pieces from 15 cm up to 1000 cm in length and of 6 mm up to 60 mm of thickness, these can be of selected colors of transparent, like green, gray, pink, blue glass and combinations of the same, the glass pieces are selected of glasses united with a plastic film, the used plastic film of the same type that in the windshield.
b) Unite two glass pieces united with a plastic film by means of a glue selected of silicone and/or glue for glass (cyanoacrilate), the glue is applied on one of the surfaces of the glass according to the selected design that can be either united figures or united lines, right after that, the other glass piece it is placed on the surface that has the glue, in such a way that they form a single piece, in the middle is the glue with the selected figure.
c) Polish the surface of one or both glass pieces according to the selected design that can be either united figures or united lines, these can be, if desired, painted.
d) Inject, at room temperature, a composition of color to the figure formed between the two glass pieces delimited by the glue, the color composition is selected of solvent base, water base, water-oil base and grinded glass finely grinding, the color composition solvent base includes pigment in a proportion of 5 up to 15% in weight, acrylic resin or of nitrocellulose in a proportion of 5 up to 15% in weight, solvent selected of thinner, acetate of butyl, acetone or xylol and mixtures of these in a proportion of 90 up to 70% in weight, and the color composition water base includes pigment in a proportion of 5 up to 15% in weight and water in a proportion of 95 up to 75% in weight and the color composition water-oil base includes 50% in weight of water and 50% in weight of oil.
e) Break one or both outer surfaces of the glass piece leaving the plastic film exposed, according to the selected design that can be united figures or united lines.
f) Break the plastic film leaving one or several orifices. The orifices can vary in an amount from 1 up to 1000 or from 0 up to 30, to inlay glasses of colors or metals selected from aluminum, bronze or iron.
g) Seal or stick the orifices at room temperature with a glue selected of silicone, acrylic resin or of nitrocellulose and glue for glass.
h) Stick the obtained glass piece with a glue to a film base selected of a polymeric and/or metallic film, the polymeric film is selected of acrylics, of polystyrene, cellulose acetate and polycarbonate, the metallic film is selected of aluminum, iron, bronze and cupper, the purpose of this film base is to support the glass piece.
i) Form the panel with the film base and the glass piece stuck according to design of dividing walls, ceilings, pictorial pictures, sculptures, floor lamps, desk or ceiling lamps, spectacular domes, stained glass and shower walls.

In an additional embodiment the process of the present invention can include the following steps:
a) Select the glass pieces in dimensions that vary of 15 cm up to 1000 cm in width, of 15 cm up to 1000 cm in length and of 6 mm up to 60 mm of thickness, these can be of transparent, green, gray, pink, blue selected glass colors and combinations of the same, the pieces glass are selected from windshield glass.
b) Unite two windshield glass pieces, for this the two glass pieces are broken of windshield in such a way that it is exhibited the plastic film of each piece, to apply on the surface of the plastic film exhibited acrylic resin or of nitrocellulose in a proportion of 5 up to 10% in weight and to apply constant pressure until they are united.
c) Polish the surface of one or both glass pieces according to the selected design that can be united figures or united lines, these can if it is desired, to be painted.
d) Break one or both faces of the outer surfaces of the glass piece in such a way that it is exhibited the plastic film according to the selected design that can be united figures or united lines, to apply on the plastic film set out a color solvent composition base includes pigment in a proportion of 8 up to 12% in weight selected of aniline of yellow, red, blue, white, black color and mixtures of these, acrylic resin or of nitrocellulose in a proportion of 25 up to 40% in weight, solvent selected of thinner, acetate of butyl, acetone or xylol and mixtures of these in a proportion of 67 up to 48% in weight.
e) Break one or both outer surfaces of the glass piece leaving the plastic film exposed, according to the selected design that can be united figures or united lines.
f) Break the plastic film being left one or several orifices, the orifices can vary in an amount of 1 until 1000 or 0 up to 30, to inlay glasses of colors or metals selected of aluminum, bronze or iron.
g) Seal or Stick, at room temperature, the orifices with a glue selected of silicone, acrylic resin or of nitrocellulose and glue for glass.
h) Stick the glass piece thus obtained with a glue to a film base selected of a polymeric and/or metallic film, the polymeric film is selected of acrylics, of polystyrene, cellulose acetate and polycarbonate, the metallic film is selected of aluminum, iron, bronze and cupper, the purpose of this film bases is to maintain the glass piece.
i) Form the panel with the film base and the glass piece stuck according to the design of dividing walls, ceilings, pictorial pictures, sculptures, floor lamps, desk or ceiling lamps, spectacular, domes, stained glass and shower walls.

### EXAMPLES

The following examples have the purpose of illustrating the invention not to limit it, any variation by an expert in the technique in the light of the present invention; will fall within the reach of the same.

### Example 1

A decorative panel prepared following the process of the present invention, with this panel form dividing walls, ceiling, pictorial pictures, floor lamps, desk or ceiling lamps, spectacular domes, stained glass and shower walls.

### Example 2

A sculpture with a decorative panel is made by the process of the present invention, to form the sculpture, glass pieces were selected to be used according to the design, later, the selected and united glass pieces were glued to a film base selected of a polymeric and/or metallic film, the polymeric film was selected of acrylics, of polystyrene, cellulose acetate and polycarbonate, the metallic film was selected of aluminum, iron, bronze and copper, the intention of this film base is to support the glass piece, but this film base can have a cylindrical, triangular form, squared or in the form of “U”, in order to give dimension to the sculpture, this is possible because the sheet of glass, when breaking itself, is manageable and easy to mold itself thanks to the plastic film. The decorative panel formed with the film base is according to the selected design.

It is pointed out that up to this date, the best known method by the applicant to bring to practice the mentioned invention; it is the one that is clear from the present description of the invention.

1. A process to make decorative or artistic panels on glass surfaces and polymeric surfaces in multiple layers, comprising the following steps:
a) Selecting glass pieces in dimensions that vary from 15 cm up to 1000 cm in width, pieces from 15 cm up to 1000 cm in length, and from 6 mm up to 60 mm in thickness, these pieces can be of selected transparent colors;
b) Uniting at least two glass pieces;
c) Polishing a surface of one or both glass pieces according to a selected design that can be united figures or united lines, which are optionally painted;
d) Injecting, at room temperature, a composition of color to the figure formed between the two glass pieces or breaking one or both faces of the outer surfaces of the glass piece and applying a color composition;
e) Breaking one or both outer surfaces of the glass piece leaving the plastic film exposed, according to the selected design that it can be united figures or united lines;
f) Breaking the plastic film leaving one or several orifices;
g) Sealing the orifices with a glue selected of silicone, acrylic resin or of nitrocellulose and glue for glass; and
h) Sticking the glass piece obtained with glue to a film base selected of a polymeric or metallic film, the purpose of this film base being to maintain the glass piece.

2. A process of making decorative or artistic panels, in accordance with claim 1, wherein the pieces glass are selected from glass of windshield or glasses united with a plastic film, the plastic film is selected of the same type that in the windshield.

3. A process of making decorative or artistic panels in accordance with claim 1, wherein the transparent glass colors are either green, gray, pink, blue or combinations of the same.

4. A process of making decorative or artistic panels in accordance with claim 1, wherein the orifices can vary from 1 up to 1000 or from 0 up to 30, to inlay glasses of colors or metals.

5. A process of making decorative or artistic panels in accordance with claim 4, wherein the metals are selected from aluminum, bronze or iron, or mixtures thereof.

6. A process of making decorative or artistic panels in accordance with claim 1, wherein the film base is a polymeric film selected from acrylics, polystyrenes, cellulose acetates, or polycarbonates, or mixtures thereof.

7. A process of making decorative or artistic panels in accordance with claim 1, wherein the film base is a metallic film selected from aluminum, iron, bronze or copper, or mixtures thereof.

8. A process of making decorative or artistic panels in accordance with claim 1, wherein the step of uniting further comprises uniting the two glass pieces with a plastic film using a glue selected of silicone or glue for glass, the glue is applied on one of the surfaces of the glass according to the selected design that can be either united figures or united lines.

9. A process of making decorative or artistic panels in accordance with claim 1, wherein the step of uniting further comprises uniting two windshield glass pieces, each of which are broken of windshield glass in such a way that it exhibits the plastic film of each piece, and appling on the surface of the plastic film exhibited either an acrylic resin or a nitrocellulose resin in a proportion of 5% to 10% in weight and applying constant pressure until the glass pieces are united.

10. A process of making decorative or artistic panels in accordance with claim 1, wherein the one or both outer surfaces of the glass are broken in such a way that the plastic film is exhibited according to the selected design that can be united figures or united lines, to apply on the plastic film set out a color solvent composition base including pigment in a proportion of % up to 12% in weight selected of aniline of yellow, red, blue, white, black color and mixtures of these, acrylic resin or a nitrocellulose resin in a proportion of 25% to 40% in weight, solvent selected of thinner, acetate of butyl, acetone or xylol and mixtures of these in a proportion of 67% to 48% in weight.

11. A process of making decorative or artistic panels in accordance with claim 8, further comprising placing the other glass piece on the surface that has the glue, in such a way that they form a single piece, having in the middle the glue with the selected figure.

12. A process of making decorative or artistic panels in accordance with claim 1, wherein the step of injecting further comprises injecting, at room temperature, a composition of color to the figure formed between the two glass pieces delimited by the glue, the color composition is selected of solvent base, water base, water-oil base and grinded glass finely grinding, the color composition solvent base including a pigment in a proportion of 5% to 15% in weight, acrylic resin or of nitrocellulose in a proportion of 5% to 15% in weight, solvent selected of thinner, acetate of butyl, acetone or xylol and mixtures of these in a proportion of up to 70% in weight, and the color composition water base including pigment in a proportion of 5% to 15% in weight and water in a proportion of up to 75% in weight and the color composition water-oil base includes about 50% in weight of water and about 50% in weight of oil.

13. A process of making decorative or artistic panels, in accordance with claim 1, further comprising integrating the panel formed into a design of dividing walls, ceilings, pictorial pictures, sculptures, floor lamps, desk or ceiling lamps, spectacular domes, stained glass and shower walls.

14. A process to make decorative or artistic panels on glass surfaces and polymeric surfaces in multiple layers, comprising the following steps:
a) Selecting the glass pieces in dimensions that vary from 15 cm up to 1000 cm in width, pieces from 15 cm up to 1000 cm in length and from 6 mm up to 60 mm in thickness, these pieces can be of selected transparent colors, like green, gray, pink, blue glass or combinations of the same, the glass pieces are selected of windshield glasses and/or glass united with a plastic film, the same type of plastic film used in the windshield;
b) Uniting two glass pieces united with a plastic film by means of a glue selected of silicone or glue for glass, the glue is applied on one of the surfaces of the glass according to the selected design that can be either united figures or united lines, right after that, the other glass piece it is placed on the surface that has the glue, in such a way that they form a single piece, in the middle is the glue with the selected figure;
c) Polishing the surface of one or both glass pieces according to a selected design that it can be united figures or united lines, these can be, if desired, painted;
d) Injecting, at room temperature, a composition of color to the figure formed between the two glass pieces delimited by the glue, the color composition is selected of solvent base, water base, water-oil base and grinded glass finely grinding, the color composition solvent base includes pigment in a proportion of 5 up to 15% in weight, acrylic resin or of nitrocellulose in a proportion of 5 up to 15% in weight, solvent selected of thinner, acetate of butyl, acetone or xylol and mixtures of these in a proportion of 90 up to 70% in weight, and the color composition water base includes pigment in a proportion of 5% to 15% in weight and water in a proportion of 95 up to 75% in weight and the color composition water-oil base includes 50% in weight of water and 50% in weight of oil;
e) Breaking one or both outer surfaces of the glass piece leaving the plastic film exposed, according to the selected design that it can be united figures or united lines;
f) Breaking the plastic film leaving one or several orifices, the orifices can vary from 1 up to 1000 or from 0 up to 30, to inlay glasses of colors or metals selected from aluminum, bronze or iron;
g) Sealing or sticking the orifices with a glue selected of silicone, acrylic resin or of nitrocellulose and glue for glass;
h) Sticking the glass piece obtained with glue to a film base selected of a polymeric and/or metallic film, the polymeric film is selected of acrylics, of polystyrene, cellulose acetate and polycarbonate, the metallic film is selected of aluminum, iron, bronze and copper, the purpose of this film base is to maintain the glass piece; and
i) Making the panel with the film base with the glass piece stuck according to the design of dividing walls, ceilings, pictorial pictures, sculptures, floor lamps, desk or ceiling lamps, spectacular domes, stained glass and shower walls.

15. A process to make decorative or artistic panels on glass surfaces and polymeric surfaces in multiple layers, comprising the following steps:
a) Selecting the glass pieces in dimensions that vary from 15 cm up to 1000 cm in width, pieces from 15 cm up to 1000 cm in length and from 6 mm up to 60 mm in thickness, these pieces can be of selected transparent colors, like green, gray, pink, blue glass or combinations of the same, the glass pieces are selected of windshield glasses or glass united with a plastic film, the same type of plastic film used in the windshield;
b) Uniting two windshield glass pieces, for this the two glass pieces are broken of windshield in such a way that it is exhibited the plastic film of each piece, to apply on the surface of the plastic film exhibited acrylic resin or of nitrocellulose in a proportion of 5% to 10% in weight and to apply constant pressure until they are united;
c) Polishing the surface of one or both glass pieces according to a selected design that it can be united figures or united lines, these can be, if desired, painted;
d) Breaking one or both faces of the outer surfaces of the glass piece in such a way that it is exhibited the plastic film according to the selected design that can be united figures or united lines, to apply on the plastic film set out a color solvent composition base includes pigment in a proportion of 8% to 12% in weight selected of aniline of yellow, red, blue, white, black color and mixtures of these, acrylic resin or of nitrocellulose in a proportion of 25 up to 40% in weight, solvent selected of thinner, acetate of butyl, acetone or xylol and mixtures of these in a proportion of 67 up to 48% in weight;
e) Breaking one or both outer surfaces of the glass piece leaving the plastic film exposed, according to the selected design that can be united figures or united lines.
f) Breaking the plastic film being left one or several orifices, the orifices can vary in an amount of 1 until 1000 or 0 up to 30, to inlay glasses of colors or metals selected of aluminum, bronze or iron;
g) Sealing or sticking, at room temperature, the orifices with a glue selected of silicone, acrylic resin or of nitrocellulose and glue for glass;
h) Sticking the glass piece thus obtained with a glue to a film base selected of a polymeric and/or metallic film, the polymeric film is selected of acrylics, of polystyrene, cellulose acetate and polycarbonate, the metallic film is selected of aluminum, iron, bronze and cupper, the purpose of this film bases is to maintain the glass piece; and
i) Forming the panel with the film base and the glass piece stuck according to the design of dividing walls, ceilings, pictorial pictures, sculptures, floor lamps, desk or ceiling lamps, spectacular, domes, stained glass and shower walls.
